(19) United States
(12) Patent Application Publication
(10) Pub. No.: US 2008/0014886 A1
(43) Pub. Date: Jan. 17, 2008

(54) METHOD AND APPARATUS FOR SEARCHING FOR FREQUENCY BURST TO ACQUIRE SYNCHRONIZATION IN A MOBILE COMMUNICATION SYSTEM

(75) Inventors: Hyoung-Geun LEE, Suwon-si (KR); Seung -Kee Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/778,413

(22) Filed: Jul. 16, 2007

(30) Foreign Application Priority Data
Jul. 14, 2006 (KR) 66596/2006

(51) Int. Cl. H04B 1/18

(52) U.S. Cl. 455/187.1

(57) ABSTRACT

A method for searching for a frequency burst (FB) by a mobile station (MS) in a mobile communication system that acquires synchronization between a base station (BS) and the MS using a frame including the FB and a synch burst (SB). In the FB search method, the MS receives a signal on the frame, performs thereon filtering for extraction of the FB in units of 1 block with a first size, and determines whether a ratio of filter input energy to filter output energy is greater than or equal to a threshold. If the ratio of filter input energy to filter output energy is greater than or equal to the threshold, the MS calculates an energy ratio by collecting, in units of a window with a predetermined size, a ratio of the filter input energy to the filter output energy, calculated in units of a block with a second size being less than the first size. The MS determines, as a position of the FB, a position of a window of an energy ratio having a peak value among energy ratios calculated in units of the window.

### PRIORITY

This application claims priority under 35 U.S.C. §119(a) to a Korean Patent Application filed in the Korean Intellectual Property Office on Jul. 14, 2006 and assigned Serial No. 2006-66596, the disclosure of which is incorporated herein by reference.

### BACKGROUND OF THE INVENTION

1. Field of the Invention

The present invention relates generally to synchronization acquisition in a mobile communication system, and in particular, to a method and apparatus for searching for a frequency burst to acquire synchronization of a cell in an asynchronous mobile communication system.

2. Description of the Related Art

Mobile communication systems can be roughly classified into synchronous systems, mainly used in the United States and Republic of Korea, and asynchronous systems, mainly used in European countries, according to a synchronization technique.

The synchronous system is a communication system that uses a technique in which a sender and a recipient exchange data at a synchronized time using a Global Positioning System (GPS) satellite, and Code Division Multiple Access (CDMA), which is a North American system, is typically used for the synchronous communication system.

On the contrary, the asynchronous system is a communication system that uses a technique in which a terminal, or Mobile Station (MS), exchanges data with a Base Station (BS) via a Relay Station (RS) without the GPS satellite, and Global System for Mobile communication (GSM), which is a European system, is typically used for the asynchronous communication system, together with General Packet Radio Service (GPRS) that can provide packet data services to compensate for shortcomings of GSM, which mainly provides voice services.

A description will be made herein of synchronization acquisition in the asynchronous system independent of the GPS satellite with reference to a GSM/GPRS system among the asynchronous systems, by way of example.

Generally, MSs in the GSM/GPRS system first acquire synchronization of a serving cell (SCell), and then acquire synchronization of a Neighbor Cell (NCell). In other words to Camp-On in a SCell, an MS acquires synchronization of the SCell. After achieving Camp-On in the SCell by acquiring synchronization of the SCell, the MS acquires synchronization of the NCell to prepare for cell reselection in an idle state or to prepare for handover in a dedicated state. The term ‘Camp-On’ as used herein refers to an operation in which an MS acquire synchronization of a corresponding BS and then registers its own MS information in the BS using BS information received over a Broadcast Control CHannel (BCCH).

Because the synchronization acquisition process is identical for both the SCell and the NCell as described above, a description of the synchronization acquisition process will be made herein without discriminating between the SCell and the NCell.

Generally, the GSM/GPRS system uses a so-called Frequency Burst (FB) signal to match synchronization between a BS and an MS. An MS performs an FB search process of searching for an FB located in an arbitrary position, and then performs a Synch Burst (SB) decoding process of decoding an SB, thereby acquiring synchronization.

More specifically, the FB search process, or the first step, is a process of searching for a position of an FB transmitted from the SCell or the NCell over a control channel, and the SB decoding process, or the second step, is a process of decoding an SB located immediately after the FB. The MS searches for a rough position of the FB using a frequency characteristic of the FB in the first process, and then acquires system information and time information included in the SB by decoding the SB in the second process. In this manner, the MS acquires synchronization with the SCell or the NCell.

FIG. 1A illustrates a structure of an FB.

Referring to FIG. 1A, the FB is composed of a 142-bit Fixed Bits part having a value 0, 3-bit Tail Bits parts before and after the Fixed Bits part, and a 8.25-bit Guard Period part having no effective value.

The FB is Gaussian-filtered Minimum Shift Keying (GMSK)-modulated before being transmitted from a BS, and becomes a sinusoidal component having a 67.7-kHz offset from the center frequency. Because the 67.7-kHz sinusoidal component continues for a 148-bit data duration, an MS detects the FB using this characteristic.

To detect FB reception, the MS passes a received signal through a 67.7-kHz Band-Pass Filter (BPF), and then calculates an energy ratio thereof. The energy ratio is calculated as a ratio of before-filtering energy (filter input energy) to after-filtering energy (filter output energy) (=‘filter output energy’/‘filter input energy’). By chasing the calculated energy ratio, the MS can determine whether it has received the FB. That is, for a non-FB, because most received signals cannot pass the filter, their energy ratio has a small value, and for an FB, because most received signals can pass the filter, their energy ratio has a high value. Therefore, the MS, if it finds a position having the highest energy ratio, can find a start position of the FB based on the highest-energy ratio position.

FIG. 1B illustrates a structure of a 51-multi frame control channel over which the FB of FIG. 1A is transmitted. The FB of FIG. 1A is transmitted from a BS to MSs in a cell of the BS over a control channel using the structure of FIG. 1B. Generally, in the 3^{rd} Generation Partnership Project (3GPP)-related standard, because the control channel is defined as a 51-multi frame structure, the control channel used for transmitting the FB will be described herein with reference to the 51-multi frame structure, by way of example.

Referring to FIG. 1B. FBs are located in frames (denoted by ‘F’) #0, #10, #20, #30 and #40 in the 51-multiframe structure. The frames each are composed of 8 time slots, and an FB is located in a first time slot, i.e. 0^{th} time slot, among the 8 time slots.

Therefore, an FB is discovered at every 10^{th} frame among the 51 frames. However, an MS receiving a signal, as it has no information on the control channel, will start the FB search from an arbitrary position. In other words, the MS can start the FB search from frames #0, #10, #20, #30 and #40 where FBs are located, among the 51 frames, or can start the FB search from the first next positions of the frames #0, #10, #20, #30 and #40, or can start the FB search from the second next positions of the frames #0, #10, #20, #30 and #40.

Therefore, to find an FB, the MS continuously performs the FB search in a maximum of 11 frames. That is, if the MS starts the FB search from a frame #1, it can find no FB until the frame #10, so the MS should continuously search 10 frames. If the MS starts the FB search from a frame #41, it can find no FB until a frame #0 that newly starts after the frame #50.

In the 51-multiframe structure of FIG. 1B. SBs (denoted by ‘S’) are located in frames #1, #11, #21, #31 and #41, which are the next frames of the frames including the FBs. The SB, as it includes synchronization information, allows the MS to acquire synchronization after decoding it. The frame including an SB (or SB frame) is located immediately after the frame including an FB (or FB frame). Therefore, if the MS finds an FB frame through the FB search, it has no need to perform an additional search process for searching for an SB frame, because the immediate next frame of the FB frame is the SB frame including an SB.

In the 51-multiframe structure of FIG. 1B, Broadcast Control CHannel (BCCH) Common Control CHannel (CCCH), and Idle (denoted by ‘1’) are included in the other frames. This structure follows the contents disclosed in the 3GPP-related standard, so only a brief description thereof will be made herein.

BCCH, a logical channel used for broadcasting signaling control information required by an MS for access and identification, includes the BS-related information, and CCCH, a channel used for call setup for communication between a BS and an MS, includes information for call setup. Further, I, an Idle frame, includes a meaningless signal.

A detailed description will now be made of a process in which an MS searches for an FB transmitted over the 51 frames, with reference to the flowchart of FIG. 2.

Referring to FIG. 2, all MS receives a signal from a BS in step 205.

Generally, the FB search is performed every predetermined 1-block time of a received signal. Therefore, the MS determines in step 210 whether the received signal has filled up 1 block. If it is determined in step 210 that the received signal has filled up 1 block, the MS proceeds to step 215, and if the received signal has failed to fill up 1 block, the MS returns to step 205 where it continues to receive a signal.

In step 215, the MS measures the energy of the 1-block signal before it inputs the received 1-block signal to a BPF, and the measured energy is filter input energy. In step 220, the MS inputs and passes the 1-block signal to/through the BPF. In step 225, the MS measures energy of the BPF-passed 1-block signal. The energy measured in step 225 is filter output energy. In step 230, the MS calculates and stores a ratio of the filter input energy measured in step 215 to the filter output energy measured in step 225. In step 235, the MS calculates and stores an FB search window filter input/output energy ratio (hereinafter ‘window energy ratio’) using the last filter input/output energy ratio (hereinafter ‘block energy ratio’) stored at intervals of 1 block. The window energy ratio can be obtained by calculating an average energy ratio of energy ratios for individual blocks for one window when as many last stored block energy ratios as one window are collected. The FB search window, the unit in which the MS calculates energy to detect an FB (148-bit signal), is herein determined to be less than a size of the FB.

In step 240, the MS compares the window energy ratio calculated in step 235 with the previously stored window energy ratios. That is, the MS determines whether there is any peak value that approximately approaches 1 and is higher than the next window energy ratio among the window energy ratios.

If the peak value is discovered in step 245, the MS proceeds to step 250 because it has reached the time that the FB terminates. However, if there is no peak value, the MS returns to step 210 because the FB has not terminated yet.

In step 250, the MS determines as a start position of an FB, a previous position by an FB length from the end position of the FB search window where the peak value was discovered, and calculates a frequency offset. Because the GMSK-modulated FB signal has a 67.7-kHz frequency characteristic, the receiver, or the MS, can determine a frequency offset by measuring a frequency of the FB signal after down-converting the FB signal.

FIG. 3 is a diagram illustrating a process of comparing window energy ratios calculated separately for each individual FB search window.

Referring to FIG. 3, an MS receives a signal from a BS and starts an FB search at an arbitrary time position 301. If as many block energy ratios as a predetermined one-FB search window size are collected from the position, the MS calculates and stores a window energy ratio for comparison of energy ratios per window. The window energy ratio is calculated herein by discarding the oldest 1 block in the one window, when the last 1 block is added while the window is shifted in units of 1 block. In this manner, the MS continues to calculate and store the window energy ratio, and the stored window energy ratio is indicated in an energy ratio chart as shown in FIG. 3.

If an FB is included in the FB search window, the energy ratio will increase. Therefore, as the FB starts to be included in the FB search window an energy ratio 302 starts to increase. In addition, if all FBs are included in the FB search window, an energy ratio 303 will be the peak value. After passing a point 304 where the window energy ratio is the peak value, signals other than the FB are received, so the energy ratio may decrease. Therefore, because the peak-window energy ratio point is an end time of the FB, the MS can find a start position of the FB if it shifts backward by an FB length 3)05 from the last point of the peak-included window.

The ‘1 block’, the unit measured to compare the window energy ratios, is very important in performing an FB search. If a size of 1 block is small, the MS will perform al FB search every small 1 block, increasing a frequency of the FB search. However, if a size of 1 block is large, the MS has no need to frequently perform the FB search. As a result, there is a high correlation between the FB block size and the FB search operation time. In addition, there is also a high correlation between them and their errors. In other words, a decrease in the size of the 1 block where an FB is checked increases the operation time of the FB search, but decreases the scope that the MS should correct when it has found an FB, contributing to a decrease in the error. However, an increase in the size of the 1 block where an FB is checked decreases the operation time of the FB search, but increases the scope that the MS should correct when it has found an FB, causing an increase in the error. Therefore, the size of 1 block should be determined taking the operation time and the error into account.

For example, when 1 block is set with 9 samples (used herein as tile same concept as the bits), about a 3-sample time is required for determining whether an FB has been received according to the FB search algorithm shown in FIG. 2. The MS waits for a 1-block signal for the remaining 6 samples.

In this case the FB search time is a 3-sample time, and the remaining 6-sample sample time is a waiting time. Therefore, for the FB search, the MS waits until 1 block is filled up, without performing the FB search operation for the 6 samples, ⅔ of the 9 samples. However, for this waiting time, the MS can perform other operations. For example, the MS can perform other operations for the waiting time using an algorithm to allow it to perform GSM/GPRS-related operations. For example, an FB Self-Scheduling algorithm performs a call-related audio processing operation while performing an FB search of an NCell particularly in a GSM dedicated state or a GPRS Packet Transfer Mode.

As described above, however, the FB search operation can be performed over a maximum of 1 frames, and because 1 frame is composed of 8 time slots in the GSM/GPRS system, the MS should search a maximum of 88 time slots to find 1 time slot including an FB. Besides, the MS cannot perform other operations for the FB search operation time other than the waiting time. Therefore, the MS performs an FB search at a time after collecting received signals in units of blocks as described in FIG. 2, thereby reducing the FB search operation time. This is because the MS can perform other task operations during the time that it waits until a predetermined number of blocks are filled with signals.

Therefore, if a size of 1 block increases, the MS can perform other operations for the signal waiting time, thereby contributing to a decrease in the overall FB search operation time. However, the increase in the size of 1 block increases the error. Because the scope in which the MS can correct a synchronization error in the FB search is predetermined, the MS cannot set the size of 1 block too large and should take the error into account. Therefore, the conventional FB search commonly sets the block size taking into account both a timing error scope of the FB position, permitted by the contrary FB search, and a reduction in the operation time, and fixes the set block size.

However, in the interval where no FB is discovered, because there is no need to take the error into consideration, it is important to prevent an increase in the FB search time, and in the interval where an FB is discovered, it is important to correctly receive information for synchronization acquisition regardless of the FB search time, so it is important to accurately correct the error. Therefore, there is a need for a technique for efficiently performing an FB search by setting the block size separately for the interval where the FB is discovered and the interval where no FB is discovered.

### SUMMARY OF THE INVENTION

An aspect of the present invention is to address at least the problems and/or disadvantages above and to provide at least the advantages described below. Accordingly, an aspect of the present invention is to provide a method and apparatus for efficiently correctly acquiring synchronization in a mobile communication system.

Another aspect of the present invention is to provide an FB search method and apparatus for reducing an actual FB search operation time and a timing error in a GSM/GPRS system.

According to one aspect of the present invention, there is provided a method for searching for a frequency burst (FB) by a mobile station (MS) in a mobile communication system that acquires synchronization between a base station (BS) and the MS using a frame including the FB and a synch burst (SB). The FB search method includes receiving a signal on the frame, performing thereon filtering for extraction of the FB in units of 1 block with a first size, and determining whether a ratio of filter input energy to filter output energy is greater than or equal to a threshold; when the ratio of filter input energy to filter output energy is greater than or equal to the threshold, calculating an energy ratio by collecting, in units of a window with a predetermined size, a ratio of the filter input energy to the filter output energy calculated in units of a block with a second size being less than the first size; and determining, as a position of the FB, a position of a window of an energy ratio having a peak value among energy ratios calculated in units of the window.

According to another aspect of the present invention, there is provided a method for searching for a frequency burst (FB) by a mobile station (MS) in a mobile communication system that acquires synchronization between a base station (BS) and the MS using a frame including the FB and a synch burst (SB). The FB search method includes filtering a predetermined number of samples extracted from both edges among samples of 1 block in units of 1 block predetermined for a signal on the frame, and calculating a ratio of filter input energy to filter output energy; calculating window-based energy ratios by collecting the calculated block-based energy ratio in units of a predetermined window; and determining, as a position of the FB, a position of a window of an energy ratio having a peak value among the window-based energy ratios.

According to further another aspect of the present invention there is provided an apparatus for searching for a frequency burst (FB) by a mobile station (MS) in a mobile communication system that acquires synchronization between a base station (BS) and the MS using a frame including the FB and a synch burst (SB). The FB search apparatus includes a signal receiver for receiving a frame signal from the BS; a signal storage for storing the received frame signal; and an FB searcher for, when a ratio of filter input energy to filter output energy, obtained in units of 1 block with a first size for the frame signal output from the signal storage, exceeds a predetermined threshold, calculating window-based energy ratios by collecting in units of a predetermined window, a ratio of the filter input energy to the filter output energy, calculated in units of 1 block with a second size being less than the first size, and determining a position of the FB according to a window of an energy ratio having a peak value among the window-based energy ratios.

According to yet another aspect of the present invention there is provided an apparatus for searching for a frequency burst (FB) by a mobile station (MS) in a mobile communication system that acquires synchronization between a base station (BS) and the MS using a frame including the FB and a synch burst (SB). The FB search apparatus includes a signal receiver for receiving a frame signal from the BS: a signal storage for storing the received frame signal: and an FB searcher for calculating window-based energy ratios by collecting a ratio of filter input energy to filter output energy in units of a predetermined window using a predetermined number of samples extracted from both edges among samples of 1 block predetermined for a frame signal output from the signal storage, and determining a position of the FB according to a window of the energy ratio having the peak value among the window-based energy ratios.

According to still another aspect of the present invention, there is provided a method for searching for a frequency burst (FB) by a mobile station (MS) in a mobile communication system that acquires synchronization between a base station (BS) and the MS using a frame including the FB and a synch burst (SB). The FB search method includes receiving a frame signal, shifting a window in units of 1 block with a first size, performing thereon filtering for FB extraction, and determining whether a ratio of filter input energy to filter output energy is greater than or equal to a threshold: when the ratio of filter input energy to filter output energy is greater than or equal to the threshold, shifting the window in units of a block with a second size being smaller than the first size, and calculating a ratio of the filter input energy to filter output energy of the window: and determining, as a position of the FB, a position of a window of an energy ratio having a peak value among energy ratios calculated in units of the window.

### BRIEF DESCRIPTION OF THE DRAWINGS

The above and other aspects, features and advantages of the present invention will become more apparent from the following detailed description when taken in conjunction with the accompanying drawings in which:

FIG. 1A is a diagram illustrating a structure of an FB;

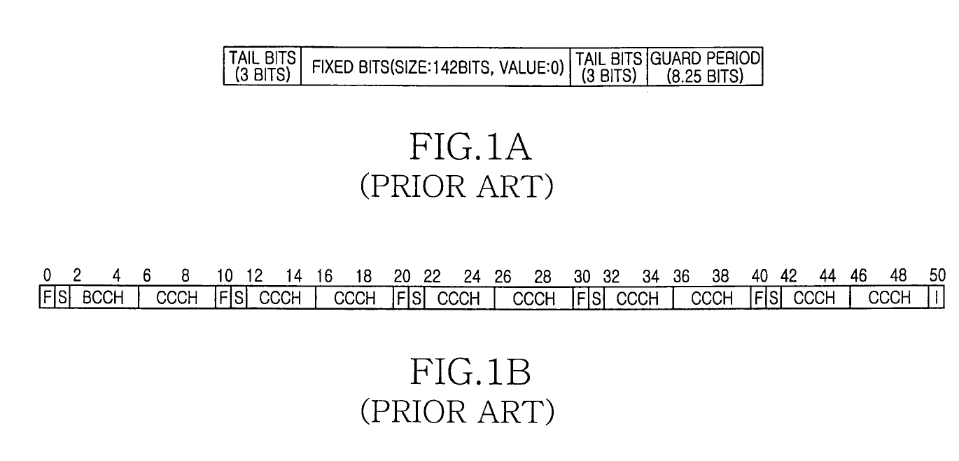

FIG. 1B is a diagram illustrating a structure of a 51-multiframe control channel over which the FB of FIG. 1A is transmitted:

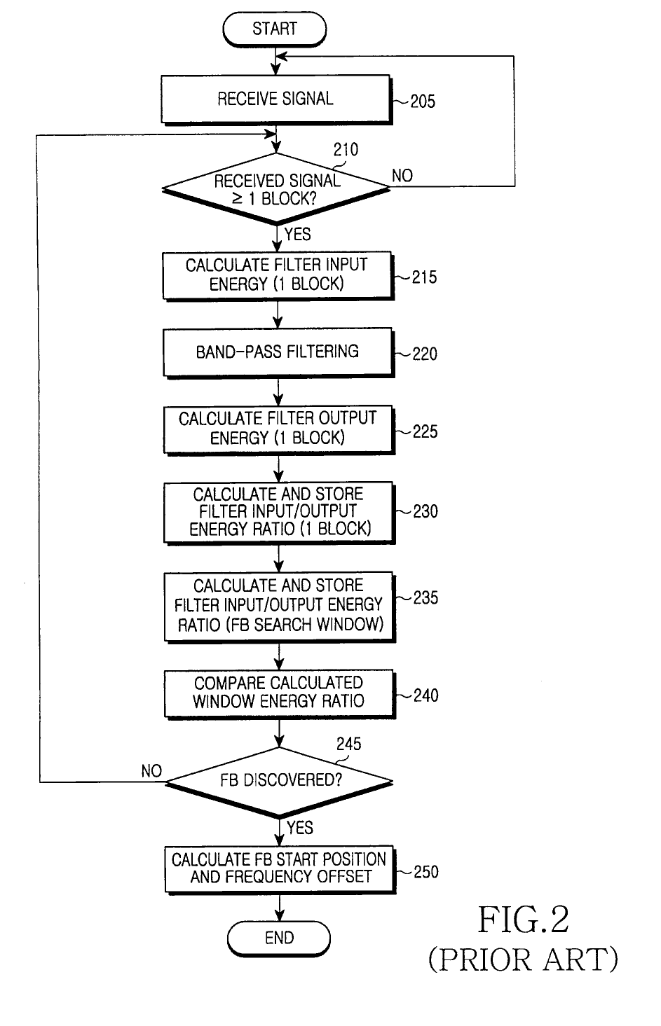

FIG. 2 is a flowchart illustrating an FB search process;

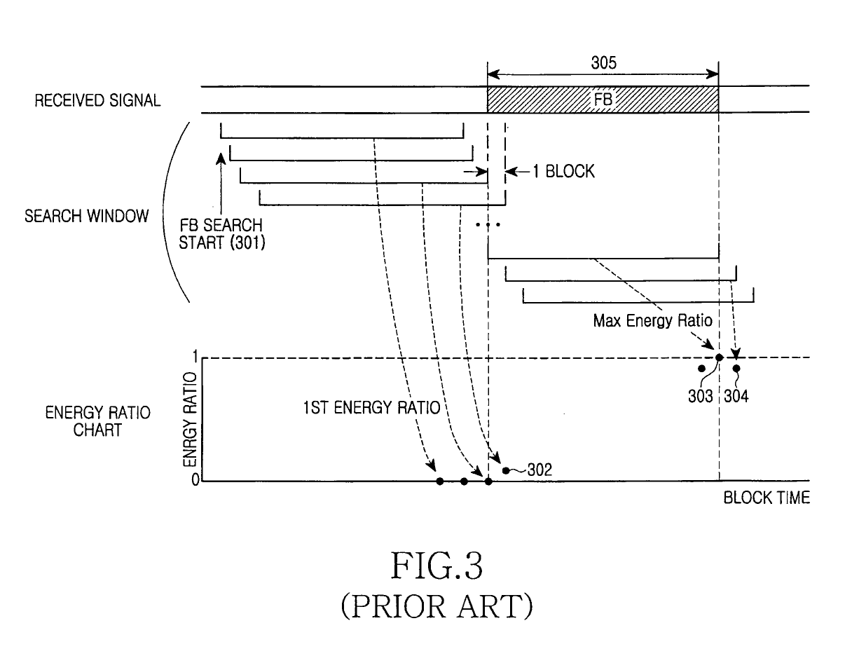

FIG. 3 is a diagram illustrating a process of comparing window energy ratios calculated separately for each individual FB search window:

FIGS. 4A and 4B are flowcharts illustrating an operation of performing an FB search in an MS according to an embodiment of the present invention:

FIG. 5 is a diagram illustrating a process of comparing energy ratios calculated separately for individual FB search windows according to a preferred embodiment of the present invention: and

FIG. 6 is a diagram illustrating a structure of an MS that performs an FB search for synchronization acquisition according to a preferred embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

As described above, an FB search can be performed for (during) a maximum of 11 frames. However, the interval where the FB is actually discovered is no more than 1 time slot in one frame composed of 8 time slots. The GSM/GPRS system where 1 frame is composed of 8 time slots, performs the FB search for a maximum of 88 time slots, and finds an FB corresponding to one of the time slots. Therefore, the FB search is performed in a non-FB received state for most time, and after an FB is received, the FB search is performed only for about 1 time slot.

Because there is no need to take into account an error of an FB position before FB reception that occupies the most FB search time, the present invention sets a large block size so as to reduce the FB search operation time, and reduces the block size for about a 1-time slot time in which it finds a correct FB position after detecting a start of the FB reception, thereby maximally reducing the FB search error and thus facilitating an efficient FB search operation.

Therefore, the present invention sets a large block size in an interval before an FB is received, and sets a small block size for the 1-time slot interval after an FB is received. Herein, the set large block size means a block size larger than the conventionally set block size, and the set small block size means a block size smaller than the conventionally set block size. The present invention applies different block sizes according to FB reception in this manner, thereby minimizing both the operation time and the FB search error.

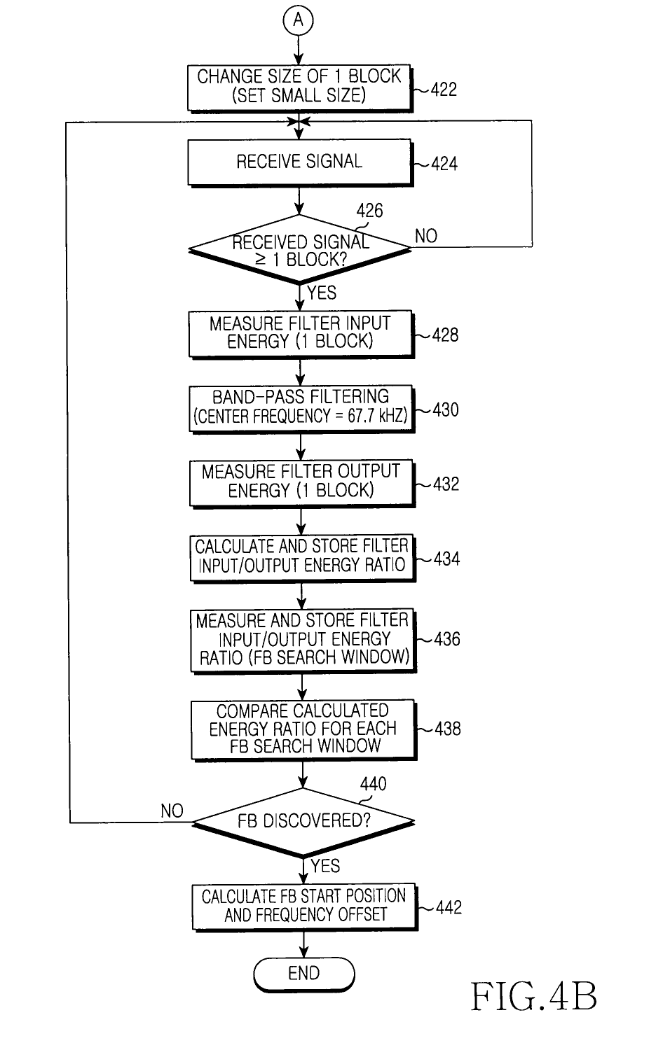

FIGS. 4A and 4B are flowcharts illustrating an operation of performing FB search in an MS according to an embodiment of the present invention.

Referring to FIGS. 4A and 4B, an MS sets a size of 1 block in step 402. Because no FB has been received yet, the MS sets the size of 1 block to a first value larger than the conventionally used reference size. In step 404, the MS receives a signal until the set 1 block is filled up.

In step 406, the MS determines whether the received signal has filled up 1 block. If the received signal has filled up 1 block, the MS proceeds to step 408. However, if the received signal has failed to fill up 1 block, the MS returns to step 404 where it continues to receive a signal.

In step 408, the MS extracts only both edge parts (Y samples) of the block without fully processing the received 1-block signal.

In the present invention, the MS measures before-BPF energy and after-BPF energy using only the both edge parts of the received 1-block signal without fully processing it, and then calculates a ratio of the before-BPF energy to the after-BPF energy, thereby determining FB reception (whether the FB has been received). In this manner, the present invention can reduce the operation time as compared to when it fully processes 1 block. If FB components are contained in both edges of 1 block, there is no need to calculate a block energy ratio with respect to the entire block because the central part will also have FB components. Therefore, the present invention can reduce the operation time by extracting only a part of the 1-block signal for calculation of a block energy ratio.

In step 410, the MS measures energy before it passes the extracted Y samples through the BPF. The energy ratio measured in step 410 is filter input energy. In step 412, the MS inputs and passes the extracted Y samples to/through a BPF with center frequency=67.7 kHz.

In step 414, the MS measures energy of the BPF-passed Y output samples. The energy of the Y samples measured in step 414 is filter output energy.

In step 416, the MS calculates a ratio of the filter input energy of Y samples measured in step 410 to the filter output energy measured in step 414.

In step 418, the MS compares the energy ratios calculated in step 416 with a predetermined threshold.

In step 420, the MS determines whether the energy ratio calculated in step 416 exceeds the threshold. If it is determined that the energy ratio is greater than the threshold, the MS proceeds to step 422 of FIG. 4B, and if the energy ratio is not greater than the threshold, the MS returns to step 406. The threshold is a reference value used for determining whether the FB has been received.

In step 422, the MS down-changes the size of 1 block, which was set in step 402, because the window energy ratio greater than the threshold means that the MS has received at least a part of the FB. In this case, the MS sets the size of 1 block less than the reference size, thereby reducing scope of a synchronization error.

In step 424, the MS receives a signal until 1 block with the size set in step 422 is filled up.

In step 426, the MS determines whether the received signal has filled up 1 block. If the received signal has filled up 1 block, the MS proceeds to step 428, and if the received signal has failed to fill up 1 block, the MS returns to step 424 where it continues to receive a signal.

In step 428, the MS measures energy for all samples of the received 1 block signal before inputting them to the BPF. The energy measured in step 428 is BPF input energy.

In step 430, the MS inputs and passes the received signal to/through the BPF with center frequency=67.7 kHz.

In step 432, the MS measures energy of the BPF-passed 1 block signal. The energy measured in step 432 is BPF output energy.

In step 434, the MS calculates and stores a ratio of the block energy measured in step 428 to the block energy measured in step 432.

In step 436, the MS calculates and stores window energy from a predetermined number of previous block energy ratios including the energy ratio calculated for the 1 block signal.

In step 438, the MS compares the window energy ratio calculated in step 436 with the previously stored window energy ratios. That is, the MS determines whether there is a peak value that approximately approaches 1 and is greater than the next window filter input/output energy ratio, among the window energy ratios. If it is determined that the peak value is discovered, the MS determines the final block of the peak-discovered FB search window as an end time of the FB. Herein, the point where the window energy ratio is the peak value means a position of an FB search window that has a very high energy ratio compared to the preceding/following FB search windows.

In step 440, the MS determines whether the point where the window energy ratio is a peak value is discovered. If the point is discovered, the MS proceeds to step 442, and if the point is not discovered, the MS returns to step 424 where it continues to receive a signal.

In step 442, the MS determines, as a start position of the FB, a previous position by an FB length from the point where the window energy ratio is a peak value, and calculates a frequency offset of the FB. Because a GMSK-modulated FB signal has a 67.7-kHz frequency characteristic, the receiver, or the MS, can determine a frequency offset by measuring a frequency of the FB signal after down-converting the FB signal.

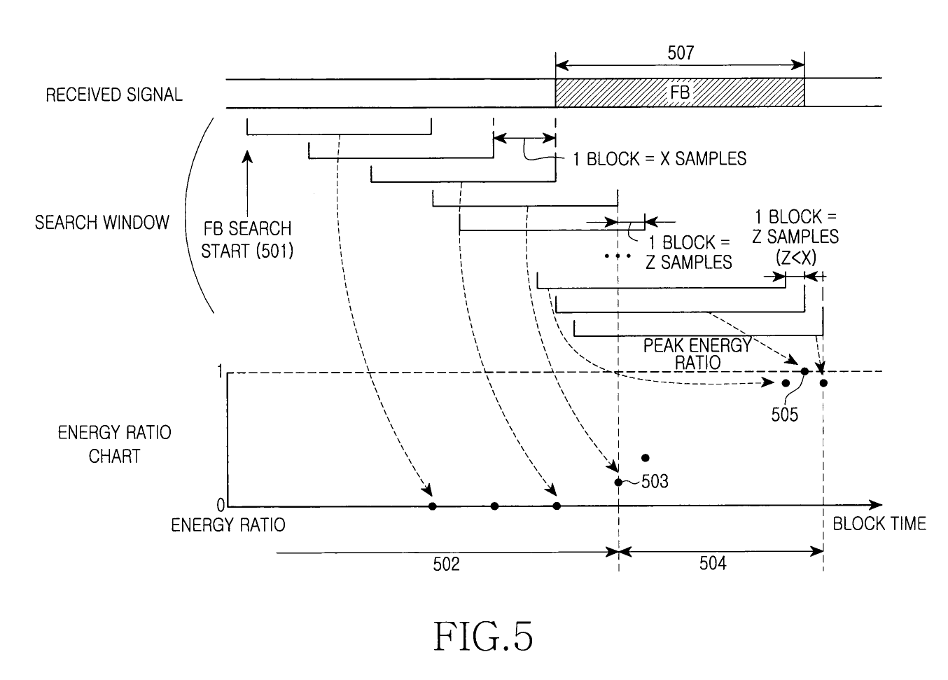

FIG. 5 is a diagram illustrating a process of comparing energy ratios calculated separately for individual FB search windows according to a preferred embodiment of the present invention.

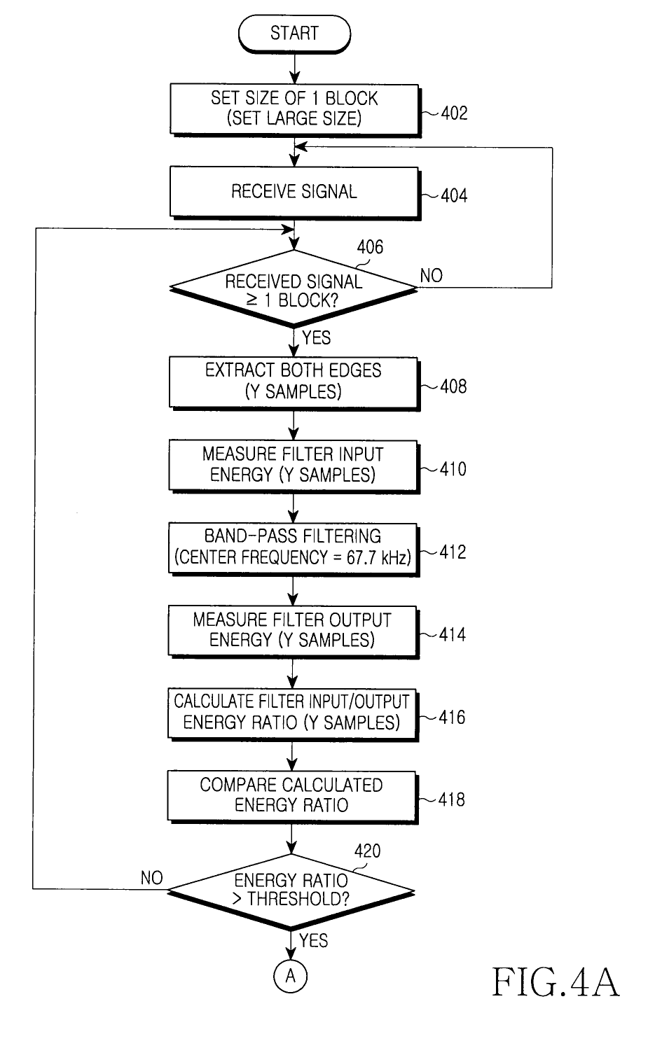

Referring to FIG. 5, similarly to FIG. 3, an MS receives a signal from a BS and starts an FB search at an arbitrary position 501. If as many block energy ratios as a predetermined one-FB search window size are collected from position 501, the MS calculates and stores window energy ratios for comparison of energy ratios per FB search window.

The window energy ratio can be obtained herein by calculating an average of block energy ratios collected for one FB search window, when as many last stored block energy ratios as one window are collected. The FB search window, the unit in which the MS calculates energy to detect an FB (142-bit signal), is herein determined to be less than a size of the FB.

The MS continues to calculate and store the FB search window filter input/output energy ratio by discarding the oldest 1 block in the one window when the last 1 block is added while the FB search window is shifted in units of 1 block with a predetermined size in a received signal. The stored FB search window filter input/output energy ratio is indicated in an energy ratio chart as shown in FIG. 5.

The present invention sets a size of 1 block to a value (assumed herein to have X samples) being greater than a predetermined reference in an interval 502 where no FB is discovered. The window energy ratio calculated by newly adding 1 block and discarding the oldest 1 block is calculated every block with the preset X-sample size. In other words, in the interval 502 where none of the FB is discovered, because the present invention calculates a window energy ratio every block with a size (X samples) being greater than the predetermined reference, intervals indicated in the energy ratio chart are long and the window energy ratio is ‘0’ as shown in FIG. 5.

As at least a part of the FB is included, a window energy ratio 503 is greater than ‘0’. In an interval 504 where the FB is included, the MS changes the size of 1 block, which was set in the interval 502, to a value (assumed herein to have Z samples) being less than a predetermined reference. Therefore, the window energy ratio is calculated every block with the changed Z-sample size. In other words, in the interval 504 where the FB is included, because the MS calculates a window energy ratio every block with a size (Z samples) being less than the predetermined reference, intervals indicated in the energy ratio chart are short and the energy ratio increases to approach ‘1’ as shown in FIG. 5. Herein, the Z-sample value is less than the X-sample value.

In the interval 504 where the FB is included, if the window energy ratio increases to approximately approach ‘1’ and a peak value 505 being higher than the next window energy ratio is discovered, the MS determines the point where the peak value 505 is discovered, as a point where the FB terminates. Therefore, the MS determines, as a start position of the FB, a previous position by an FB length 507 from the end point of the FB search window including the peak value 505, and calculates a frequency offset.

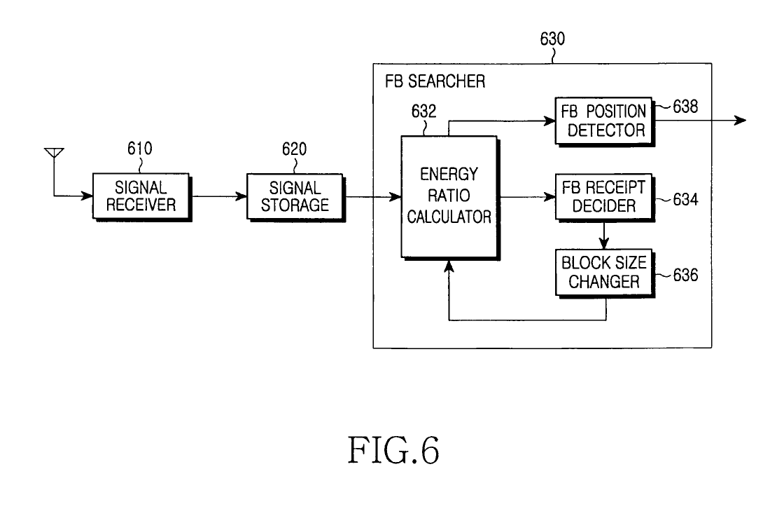

FIG. 6 is a diagram illustrating a structure of an MS that performs an FB search for synchronization acquisition according to a preferred embodiment of the present invention. Only the structure related to an FB search operation of the MS is shown herein, and the other structure is omitted.

Referring to FIG. 6, a signal receiver 610 receives a Radio Frequency (RF) signal from a BS via an antenna. The received RF analog signal is converted into a baseband digital signal through down conversion and Analog-to-Digital Conversion (ADC), and for this, the signal receiver 61(0 can include an RF un it and an ADC converter.

A signal storage 620 is a memory in which the ADC-converted signal is stored. The signal stored in the signal storage 620 is delivered to an FB searcher 630 for an FB search.

The FB searcher 630 searches for an FB according to an embodiment of the present invention, and detects an FB position, and the FB searcher 630 can include an energy ratio calculator 632, an FB position detector 638, an FB reception decider 634, and a block size changer 636.

The energy ratio calculator 632 measures before-filtering energy and after-filtering energy for the signals provided from the signal storage 620, using a BPF that passes only the FB component, calculates a ratio of the before-filtering energy to the after-filtering energy, and delivers the calculated energy ratio to the FB reception decider 634. The energy ratio is calculated every block, and until the energy ratio exceeds a predetermined threshold, the energy ratio is calculated for some samples located in both ends of 1 block with a predetermined size. If the FB reception decider 634 determines that the energy ratio exceeds the threshold, the block size changer 636 orders the energy ratio calculator 632 to change the set size of 1 block. In response to the order from the block size changer 636, the energy ratio calculator 632 measures energy of the full size-changed 1 block, and then calculates ratios of the energies measured for the full 1 block. In addition, the energy ratio calculator 632 calculates a window energy ratio by collecting the energy ratios calculated in units of the 1 block and delivers the window energy ratio to the FB position detector 638.

That is, the FB reception decider 634 determines whether an energy ratio provided from the energy ratio calculator 632 exceeds a predetermined threshold, thereby determining whether an FB has been received. If the provided energy ratio does not exceed the threshold, the FB reception decider 634 orders the block size changer 636 not to change the previously set size of 1 block. However, if the energy ratio exceeds the threshold, the FB reception decider 634 orders the block size changer 636 to down-changed the set block size. Herein, the energy ratio exceeding the threshold means that at least a part of the FB is included in the received signal.

The block size changer 636 changes a size of 1 block, used for calculating before-BPF energy and after-BPF energy, according to the order from the FB reception decider 634.

The FB position detector 638 compares the window energy ratios provided from the energy ratio calculator 632 to determine whether there is a peak value. With use of the peak value, the MS can find a start position of an FB, and if the MS detects the start position of the FB, it can detect a rough position the SCell or the NCell. The start position information of the FB is later used for an SB search.

As described above, the present invention performs an FB search in two steps of determining FB reception and detecting a correct FB position, thereby r educing the FB search operation time and minimizing an error of the FB position.

In other words, with the application of the process of the present invention, it is possible to obtain gain even for the forgoing exemplary case where 1 block is composed of 9 samples (used herein as the same concept as the bits). A gain in terms of the operation time will first be described below. Because the actual operation time required for processing 1 block by the FB search method is about 3 samples, a 48-sample operation time is actually consumed for a 16-block FB search window. However, when the present invention sets the number of samples extracted from one edge of 1 block to 9 samples, and sets in a first step a length of 1 block to ‘FB search window’—‘9 samples’, only the time required for processing data extracted from both edges of 1 block is consumed as a time required for performing the FB search for the FB search window, so the actual operation time is reduced to 6 samples. That is, with the application of the present invention, the actual operation time reduces to ⅛ of the FB search operation time. A gain of the operation time depends on a length of 1 block and the amount of data extracted from 1 block.

The reduction in the FB search operation time, obtained with the application of the first step of determining FB reception, provides the following two kinds of gains. First, during the FB search operation, the MS can perform many other GSM/GPRS-related operations which are irrelevant to the FB search. Second, the MS can reduce power consumption necessary for the FB search.

In addition, the second step of detecting an accurate FB position reduces a size of 1 block compared to the prior art, thereby reducing an error of the FB position. The maximum error of the FB position is defined as an integer part of ‘(size of 1 block)/2’, because the MS finds an FB position in units of 1 block. In the first step of the FB search, because a length of 1 block is 9 samples, a position of an FB can experience an error of a maximum of 4 samples. However, in the second step of the present invention, if a length of 1 block decreases to 5 samples, the error of an FB position reduces to a maximum of 2 samples. Therefore, with the application of the present invention, the MS can correctly find an FB position compared to the prior art.

As is apparent from the foregoing description, in a mobile communication system, particularly in the GSM/GPRS system, the present invention flexibly changes a size of a block, which is a unit for calculating an energy ratio, according to FB detection, thereby reducing an actual FB search operation time to allow more time allocation for other operations except for the FB search, and reducing an error of timing synchronization to facilitate accurate acquisition of timing synchronization.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for searching for a frequency burst (FB) by a mobile station (MS) in a mobile communication system that acquires synchronization between a base station (BS) and the MS using a frame including the FB and a synch burst (SB), the method comprising:
receiving a signal on the frame, performing thereon filtering for extraction of the FB in units of 1 block with a first size, and determining whether a ratio of filter input energy to filter output energy is greater than or equal to a threshold;
when the ratio of filter input energy to filter output energy is greater than or equal to the threshold, calculating an energy ratio by collecting, in units of a window with a predetermined size, a ratio of the filter input energy to the filter output energy, calculated in units of a block with a second size being less than the first size: and
determining, as a position of the FB, a position of a window of an energy ratio having a peak value among energy ratios calculated in units of the window.

2. The method of claim 1, wherein the window-based energy ratios are each calculated by averaging energy ratios calculated in units of 1 block with the second size while shifting the window by 1 block with the second size for the received signal.

3. The method of claim 2, wherein the threshold is a reference value indicating a start of reception of the FB.

4. The method of claim 1, wherein the filter input energy and the filter output energy, obtained in units of 1 block with the first size, are measured using a predetermined number of samples extracted from both edges among samples of 1 block.

5. The method of claim 2, wherein the filter output energy is an energy value of a signal output from a band-pass filter (BPF) with a center frequency=67.7 kHz to which the received signal is applied.

6. The method of claim 1, wherein the peak value is a value of an energy ratio being greater than preceding and following energy ratios among the window energy ratios.

7. The method of claim 6, wherein determining position of the FB comprises:
determining a point where the peak value is discovered, as an end point of the FB, and determining a start position of the FB based on the end point.

8. A method for searching for a frequency burst (FB) by a mobile station (MS) in a mobile communication system that acquires synchronization between a base station (BS) and the MS using a frame including the FB and a synch burst (SB), the method comprising:
filtering a predetermined number of samples extracted from both edges among samples of 1 block in units of 1 block predetermined for a signal on the frame, and calculating a ratio of filter input energy to filter output energy;
calculating window-based energy ratios by collecting the calculated block-based energy ratio in units of a predetermined window; and
determining, as a position of the FB, a position of a window of an energy ratio having a peak value among the window-based energy ratios.

9. The method of claim 8, wherein calculating a ratio of filter input energy to filter output energy comprises:
when a ratio of filter input energy to filter output energy, obtained in units of 1 block with a first size predetermined for the frame signal, is greater than or equal to a predetermined threshold, calculating a ratio of filter input energy to filter output energy for all samples, obtained in units of 1 block with a second size being less than the first size.

10. The method of claim 8, wherein determining a position of the FB comprises:
determining a point where the peak value is discovered, as an end point of the FB, and determining a start position of the FB based on the end point.

11. An apparatus for searching for a frequency burst (FB) by a mobile station (MS) in a mobile communication system that acquires synchronization between a base station (BS) and the MS using a frame including the FB and a synch burst (SB), the apparatus comprising:
a signal receiver for receiving a frame signal from the BS:
a signal storage for storing the received frame signal; and
an FB searcher for, when a ratio of filter input energy to filter output energy, obtained in units of 1 block with a first size for the frame signal output from the signal storage, exceeds a predetermined threshold, calculating window-based energy ratios by collecting, in units of a predetermined window, a ratio of the filter input energy to the filter output energy, calculated in units of 1 block with a second size being less than the first size, and determining a position of the FB according to a window of an energy ratio having a peak value among the window-based energy ratios.

12. The apparatus of claim 11, wherein the FB searcher comprises:
an energy ratio calculator for calculating a ratio of filter input energy to filter output energy, obtained in units of 1 block for the stored received signal, and calculating window-based energy ratios by collecting the block-based energy ratios in units of a predetermined window:
a decider for comparing the block-based energy ratio with a predetermined threshold, and determining whether to maintain the size of 1 block at the first size or whether to change the size of 1 block to the second size according to the comparison result;
a block size changer for sending a notification indicating a change in the size of 1 block to the second size to the energy ratio calculator according to an order from the decider, thereby ordering the energy ratio calculator to calculate the window-based energy ratios by collecting, in units of a predetermined window, energy ratios obtained in units of 1 block with the changed size, and
an FB detector for comparing the window-based energy ratios to discover an energy ratio having a peak value among the window-based energy ratios, and determining a position of the FB according to a window of the energy ratio having the peak value:
wherein 1 block with the second size is set smaller than 1 block with the first size.

13. The apparatus of claim 11, wherein the window-based energy ratios are each calculated by averaging energy ratios calculated in units of 1 block with the second size while shifting the window by 1 block with the second size for the received signal.

14. The apparatus of claim 11, wherein the decider compares the energy ratio of 1 block with the threshold, and if the energy ratio exceeds the threshold, determines to change the block with the first size to the block with the second size.

15. The apparatus of claim 14, wherein the threshold is a reference value indicating a start of reception of the FB.

16. The apparatus of claim 11, wherein the filter input energy and the filter output energy, obtained in units of 1 block with the first size, are measured using a predetermined number of samples extracted from both edges among samples of 1 block.

17. The apparatus of claim 16, wherein the filter output energy is an energy value of a signal output from a band-pass filter (BPF) with a center frequency=67.7 kHz to which the received signal is applied.

18. The apparatus of claim 12, wherein the peak value is a value of an energy ratio being greater than preceding and following energy ratios among the window energy ratios.

19. The apparatus of claim 18, wherein the FB detector determines a point where the peak value is discovered, as an end point of the FB, and determines a start position of the FB based on the end point.

20. An apparatus for searching for a frequency burst (FB) by a mobile station (MS) in a mobile communication system that acquires synchronization between a base station (BS) and the MS using a frame including the FB and a synch burst (SB), the apparatus comprising:
a signal receiver for receiving a frame signal from the BS:
a signal storage for storing the received frame signal; and
an FB searcher for calculating window-based energy ratios by collecting a ratio of filter input energy to filter output energy in units of a predetermined window using a predetermined number of samples extracted from both edges among samples of 1 block predetermined for a frame signal output from the signal storage, and determining a position of the FB according to a window of the energy ratio having the peak value among the window-based energy ratios.

21. The apparatus of claim 20, wherein when a ratio of filter input energy to filter output energy, obtained in units of 1 block with a first size predetermined for the signal received from the BS, is greater than or equal to a predetermined threshold, the FB searcher calculates a ratio of filter input energy to filter output energy for all samples, obtained in units of 1 block with a second size being less than the first size.

22. The apparatus of claim 20, wherein the FB searcher determines a point where the peak value is discovered, as an end point of the FB, and determines a start position of the FB based on the end point.

23. A method for searching for a frequency burst (FB) by a mobile station (MS) in a mobile communication system that acquires synchronization between a base station (BS) and the MS using a frame including the FB and a synch burst (SB), the method comprising:
receiving a frame signal, shifting a window in units of 1 block with a first size, performing thereon filtering for FB extraction, and determining whether a ratio of filter input energy to filter output energy is greater than or equal to a threshold;
when the ratio of filter input energy to filter output energy is greater than or equal to the threshold, shifting the window in units of a block with a second size being smaller than the first size, and calculating a ratio of the filter input energy to filter output energy of the window; and
determining, as a position of the FB, a position of a window of an energy ratio having a peak value among energy ratios calculated in units of the window.
